(19) United States
(12) Patent Application Publication
(10) Pub. No.: US 2021/0395144 A1
(43) Pub. Date: Dec. 23, 2021

(54) GROUT MATERIAL FOR HEAT TRANSFER

(71) Applicant: BIC, Inc., Daejeon (KR)

(72) Inventor: Kang BAI, Seoul (KR)

(21) Appl. No.: 17/152,484

(22) Filed: Jan. 19, 2021

(30) Foreign Application Priority Data
Jun. 22, 2020 (KR) 10-2020-0075860

(51) Int. Cl. C04B 14/02; C04B 28/06; C04B 14/10

(52) U.S. Cl. CPC C04B 14/024; C04B 2111/70; C04B 14/104; C04B 28/06

(57) ABSTRACT

A grout material for heat transfer according to the present invention comprises a sand particle; and an outer layer coated on the surface of individual sand particle, wherein the outer layer is composed of a mixture of graphite powder and a hydraulic inorganic binder.

A method for producing the grout material for heat transfer according to the present invention comprises the steps of: mixing graphite powder and a hydraulic inorganic binder; coating the mixture of graphite powder and the hydraulic inorganic binder on the outer surface of the sand particles while stirring the sand particles by spraying water; curing the hydraulic inorganic binder on the sand particles on which the mixture of graphite powder and the hydraulic inorganic binder is coated; and drying the sand particles on which the mixture of graphite powder and the hydraulic inorganic binder is coated.

The grout material for heat transfer is mixed with the mixture of water and bentonite powder to form a slurry and is used for a grouting process in which the prepared slurry is injected to give water-proof property to the grout material for heat transfer.

This application claims priority to Korean Patent Application No. 10-2020-0075860 of which title is “Grout Material for Heat Transfer,” filed on Jun. 22, 2020, all the benefits accruing therefrom under 35 U.S.C. § 119, the disclosure of which is incorporated herein in its entirety by reference.

### TECHNICAL FIELD

The present disclosure relates to a grout material for heat transfer, and more specifically, to a grout material for heat transfer of which thermal conductivity is excellent by coating graphite powder with an inorganic binder on the surface of individual sand particles.

### BACKGROUND

Generally, underground space is secured by excavating the ground consisting of soil or bedrock, and if the state of the excavated ground is not stable, the excavation work cannot be carried out due to the risk of collapse, and if the risk is overlooked, disaster can occur.

Therefore, when excavating an underground space, reinforcing or strengthening work should be performed in various ways to ensure the stability of underground space, and the grouting process is used for that purpose. Grouting is a process of injecting appropriate fillers into cracks, cavities, and/or voids in the ground with applying pressure and is performed to prevent water leakage and to reinforce unstable ground for excavation works.

Various grouting processes are widely used in civil works such as underground excavation in urban subways or large construction sites to ensure ground stability Also, grouting is also used for waterproofing and reinforcing of weak ground, foundation reinforcement to restore inclined buildings due to vibration or groundwater level drop and to enhance the supporting power of the ground, earthquake-resistant and aseismatic design against ground vibration or earthquake as well as for special ground reinforcement at waste landfills.

In the geothermal field, the grouting work is to inject grout materials into the empty space after installing the underground heat exchangers, usually plastic pipes, in drilled holes, which is for securing ground stability as the major role of the grouting work, and for enhancing heat transfer capability between the underground heat exchangers and the underground soil by filling empty space as well as for preventing surface water infiltration and groundwater pollution into the drilled holes. In the grouting process, an injection pipe, so-called tremie pipe, is inserted into the holes, and grout in slurry form is injected through it, forced by an external injection pump, compressor, or the like.

In general, the bentonite-based or cement-based grout materials are used as geothermal grout materials and the thermal conductivity of cement-based ones are higher than that of bentonite-based ones. However, since cement-based ones have several disadvantages, such as contaminating the surrounding environment and decreasing the ground contact due to shrinking during cement curing, bentonite-based ones are widely used. Furthermore, bentonite absorbs water and expands to about 5 times its weight, and 13 to 16 times its volume. Due to these characteristics, bentonite has is widely used as a grout material for water-proof walls of civil engineering works or for underground heat exchangers of geothermal heat transfer works.

However, pure bentonite has low thermal conductivity, so the geothermal bentonite grout is required to mix the high heat transfer material, usually sand, graphite, or alumina with water. However, this mixture can't retain the stable mixed state, due to the differences in their specific gravities, and they are separated soon.

To solve this problem, Korean Patent Publication Laid-open No. 2010-0060916 discloses a method of manufacturing a compact bentonite product with a high density. According to this method, dried bentonite powder is compressed to a high-density form, and water is soaked into the compressed powder to apply a swelling pressure, and then it is dried again. When the bentonite powder is soaked with water to use in the construction site, it is easily dissociated. That means it has a problem in the peptization characteristics.

Korean Patent No. 10-1348134 discloses a method for manufacturing bentonite granules to be used for a grout material, which is prepared as a dried mixture composed of bentonite, sand, graphite, and alumina, etc.

Korean Patent No. 10-1363867 discloses a grout material comprising 40 to 50 wt. % of silica, 5 to 15 wt. % of bentonite, and 45 to 55 wt. % of water, in which silica has a particle diameter of 5 to 600 μm, and silica having a particle diameter of 45 μm or less is contained less than 5 wt. % as well as 425 μm or less than 10 wt %.

Still, in the field of geothermal grouting, there has been a demand for a grout material having excellent thermal conductivity, a satisfactory degree of waterproofness, and good constructability.

Accordingly, an object of the present invention is to provide a grout material for heat transfer which has excellent thermal conductivity compared to a conventional one.

Another object of the present invention is to provide a grouting method which has a satisfactory degree of waterproofness by controlling the mixed ratio of bentonite and water of slurry form in the construction site.

Another object of the present invention is to provide a grout material to decrease the additional cost of the high-priced graphite by using low content of it.

### SUMMARY

Graphite is a suitable grout material for heat transfer due to its high thermal conductivity. The crystal structure of graphite forms a layer, of which surfaces are made up of six carbons, has a very high thermal conductivity of 1,950 (W/mk) in a plane parallel direction, and the higher the purity of graphite is, the greater the thermal conductivity enhancement effect is. However, the higher the purity of graphite is, the more expensive it is.

However, the graphite powder is easily scattered and get lost a lot, and there is a risk of environmental pollution, if it is used directly at the construction site. In addition, workers tend to avoid using graphite powder because the black-colored powder adheres well to their clothes in the construction site and is not easily removed.

Also, when graphite is mixed with bentonite and water to form a slurry and is used in the grouting process as described above, there is a problem that bentonite and graphite are separated easily in the water due to a difference in specific gravity of both materials.

The inventors of the present invention have found that when using graphite with the high thermal conductivity as a grout material, the above disadvantages of the above-described phenomena can be eliminated by coating graphite powders on the outer surface of sand particles, where both materials are used to enhance the thermal conductivity of bentonite-based grout for heat transfer.

According to an embodiment of the present invention, a grout material for heat transfer comprises a sand particle; and an outer layer coated on the sand particle, wherein the outer layer is composed of a mixture of graphite powder and a hydraulic inorganic binder.

Preferably, the hydraulic inorganic binder is selected from the group consisting of cement, gypsum, and sodium silicate.

Preferably, the hydraulic inorganic binder is cement.

Preferably, the cement is an alumina-based rapid setting cement.

Preferably, the graphite powder in the outer layer is 0.1 to 10 wt. % based on the weight of the sand particle.

Preferably, the hydraulic inorganic binder in the outer layer is 1 to 10 wt. % based on the weight of the sand particle.

According to the present invention, a method for producing the grout material for heat transfer comprises the steps of: mixing graphite powder and a hydraulic inorganic binder; coating the mixture of graphite powder and the hydraulic inorganic binder on the outer surface of the sand particles while stirring the sand particles with water spraying; curing the hydraulic inorganic binder on the sand particles on which the mixture of graphite powder and the hydraulic inorganic binder are coated; and drying the sand particles on which coated with the mixture of graphite powder and the hydraulic inorganic binder are provided.

According to the present invention, a method of grouting process comprising the steps of: mixing water and bentonite powder and forming bentonite slurry; making the mixture slurry of the bentonite slurry and the grout material for heat transfer according to the present invention; and injecting the mixture slurry formed to give the water-proof ability to the grout material for heat transfer is provided.

Preferably, the mixing ratio of the grout material for heat transfer and bentonite powder is 5:1 to 8:1.

According to the grout material for heat transfer of the present invention, only a small amount of graphite which has high thermal conductivity with a high price is used with sand, which is a material having a relatively high thermal conductivity, thus, the thermal conductivity of a grout material for heat transfer can be enhanced at a relatively low cost.

Furthermore, the grout material for heat transfer according to the present invention is coated with an outer layer in which fine particles of graphite powder are dispersed in a hydraulic inorganic binder having a continuous structure for each particle of sand and being set with water, therefore, the graphite powder dispersed in the hydraulic inorganic binder is not easily separated even if it is mixed and injected with the bentonite slurry during the subsequent grouting process.

Also, since the grout material for heat transfer of the present invention is set as a rigid form in advance by mixing a hydraulic inorganic binder and graphite powder in a piece of closed structure equipment, it is less scattered compared to the conventional method in which the graphite powder is mixed with sand or bentonite in an outdoor open space. Therefore, pollution to the environment and workers is significantly reduced.

### BRIEF DESCRIPTION OF THE DRAWINGS

The above and other aspects, features, and advantages of certain preferred embodiments of the present disclosure will be more apparent from the following description taken in conjunction with the accompanying drawings, in which:

FIG. 1 is a cross-sectional view of a grout material for heat transfer according to the present invention;

FIG. 2 is a photograph showing the dried state of the grout material for heat transfer according to the present invention; and,

FIG. 3 is a photograph showing the mixed state of the grout material for heat transfer according to the present invention with water to form mixture slurry.

### DETAILED DESCRIPTION

In this specification, the expressions “have”, “includes”, “comprises”, etc. refer to the presence of a feature and do not preclude the presence of additional features.

All terms used herein, including technical or scientific terms, may have the same meaning as commonly understood by one of ordinary skill in the art.

Commonly used predefined terms may be construed as having the same or similar meaning as the contextual meanings of the related art and are not to be construed as an ideal or overly formal sense unless expressly defined to the contrary herein. In some cases, the terms defined herein may not be construed to exclude embodiments of the present invention.

The advantages and features of the present invention and a method of achieving them will become apparent with reference to the embodiments described below in detail together with the accompanying drawings. However, the present invention is not limited to the embodiments disclosed below and may be implemented in various other forms, and the present embodiments have only the purpose of thorough disclosure of the present invention.

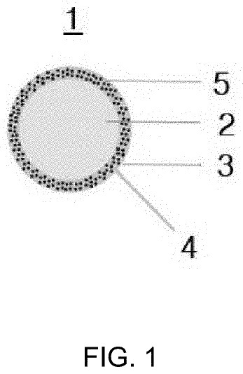

FIG. 1 is a diagram showing a cross-section of a grout material for heat transfer 1 according to the present invention, the grout material for heat transfer 1 is composed of a sand particle 2 and an outer layer 3 coated on the sand particle 2.

As the sand used for the grout material for heat transfer 1 of the present invention, river sand collected from a river or crushed sand obtained by crushing silica rock can be used. Although the shape of the river sand is relatively close to a spherical shape, it often contains organic material and other minerals, so it must be washed, separated, and classified (sieved). Though the shape of the crushed sand is sharp, and irregular compared to that of river sand, washing and/or separating processes are not required and only sieving is required.

The size of sand that can be used is No. 2 (4-8 mesh 4.75-2.36 mm) or No. 3 (8-12 mesh 2.36-1.70 mm), but not limited thereto.

In the present invention, a grout material for heat transfer 1 is prepared by coating an outer layer 3 composed of a mixture of a hydraulic inorganic binder 4 and graphite powder 5 on the outside surface of the sand particle 2.

The hydraulic inorganic binder 4 which is used in the outer layer 3 is selected from the group consisting of cement, gypsum, or sodium silicate, preferably cement, and most preferably alumina-based rapid setting cement.

To manufacture the grout material for heat transfer 1 which has the above configuration, river sand or crushed sand described above is prepared at first.

Next, a mixture for coating the outer layer 3 is formed by mixing the hydraulic inorganic binder 4 and graphite powder 5.

Though there is no particular limitation on the hydraulic inorganic binder 4 and graphite powder 5 constituting the outer layer 3, in the case of graphite, the thermal conductivity of the grout depends on the content of the graphite, but the manufacturing cost also increases accordingly, and the thermal conductivity is not proportional to the content of graphite. Preferably, the content of graphite powder 5 in the outer layer 3 is 0.1 to 10 wt. % based on the weight of the sand particles 2.

It is preferable that the hydraulic inorganic binder 4 in the outer layer is 1 to 10 wt. % based on the weight of the sand particles 2.

The mixture for coating outer layer 3, which is formed by mixing the hydraulic inorganic binder 4 and graphite powder 5 as described, and sand particles 2 are placed in an industrial mixer and stirred while the mixture of graphite powder 5 and the hydraulic inorganic binder 4 is coated on the sand particles 2.

Thereafter, water is sprayed on the sand particles 2 on which the mixture of the hydraulic inorganic binder 4 and graphite powder 5 are coated as the outer layer 2, and the hydraulic inorganic binder 4 in the outer layer 2 is formed. If the inorganic binder 4 is set in this way, even if the grout material for transfer is mixed with water and bentonite slurry during the subsequent grouting process and injected into underground heat exchangers, the graphite powder dispersed in the hydraulic inorganic binder is not easily separated. Therefore, the separation phenomenon due to the difference in specific gravity between the grout materials is significantly reduced.

The grout material for heat transfer 1 formed as described above can be used in the construction site after a drying treatment.

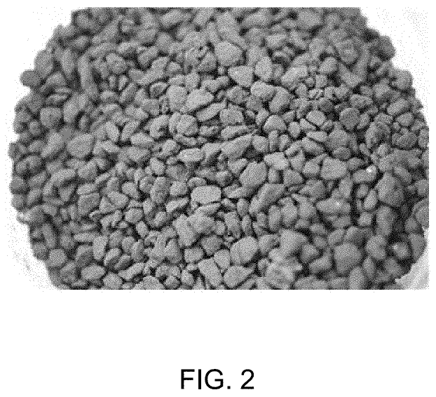

FIG. 2 shows the grout material for heat transfer 1 according to the present invention which is manufactured through the process as above.

A method of grouting process using the grout material for heat transfer 1, which is prepared as described above for the injection process into the underground boreholes, will be described.

Two important functions in the grouting process for an underground boreholes are heat transfer and the water-proof property. In the conventional grouting process for underground boreholes construction, bentonite slurry has been used for water-proof despite that the thermal conductivity of bentonite is low. According to the present invention, the grout material for heat transfer with high thermal conductivity is used, therefore, the heat transfer is already secured satisfactorily, and the second function of the grout material, namely water-proof property can be controlled by changing the composition and content of the bentonite slurry as required in the construction site before the injection process.

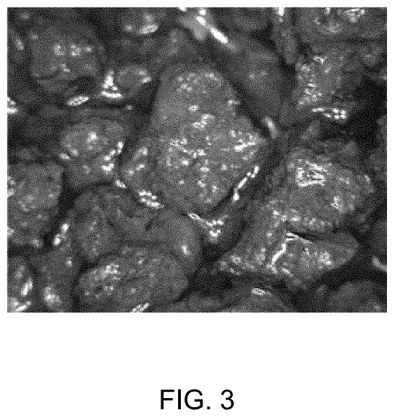

In the grouting process according to the present invention, water and bentonite powder are mixed at first. Then, the above bentonite slurry is again mixed with the grout material for heat transfer 1 according to the present invention to form a mixture slurry as shown in FIG. 3. This slurry thus formed is injected into the underground boreholes during construction.

In this specification, the present invention and its advantages have been described with reference to a specific embodiment. However, it will be apparent to those of ordinary skill in the art that various modifications and changes can be made without departing from the scope of the present invention as described in the claims below. Accordingly, the specification and drawings are to be regarded as examples of the invention rather than limitations. All such possible modifications should be made within the scope of the present invention.

What is claimed is:

1. A grout material for heat transfer comprising:
a sand particle; and
an outer layer coated on the surface of an individual sand particle,
wherein the outer layer is composed of a mixture of graphite powder and a hydraulic inorganic binder.

2. The grout material for heat transfer according to claim 1, wherein the hydraulic inorganic binder is selected from the group consisting of cement, gypsum, and sodium silicate.

3. The grout material for heat transfer according to claim 2, wherein the hydraulic inorganic binder is cement.

4. The grout material for heat transfer according to claim 2, wherein the cement is an alumina-based rapid setting cement.

5. The grout material for heat transfer according to claim 1, wherein the graphite powder in the outer layer is 0.1 to 10 wt. % based on the weight of the sand particle.

6. The grout material for heat transfer according to claim 1, wherein the hydraulic inorganic binder in the outer layer is 1 to 10 wt. % based on the weight of the sand particle.

7. A method for producing the grout material for heat transfer according to claim 1 comprising the steps of:
mixing graphite powder and a hydraulic inorganic binder;
coating the mixture of graphite powder and the hydraulic inorganic binder on the outer surface of the sand particles while stirring the sand particles by spraying water;
curing the hydraulic inorganic binder the sand particles on which the mixture of graphite powder and the hydraulic inorganic binder is coated; and
drying the sand particles on which the mixture of graphite powder and the hydraulic inorganic binder is coated.

8. A method of grouting process comprising the steps of:
mixing water and bentonite powder and forming bentonite slurry;
making the mixture slurry of the bentonite slurry and the grout material for heat transfer according to claim 1; and
injecting the mixture slurry into the boreholes to give water-proof property to the grout material for heat transfer.

9. The method of grouting process according to claim 8,
wherein the mixing ratio of the grout material for heat transfer and bentonite powder is 5:1 to 8:1.
